(19) United States
(12) Patent Application Publication
(10) Pub. No.: US 2014/0009482 A1
(43) Pub. Date: Jan. 9, 2014

(54) METHODS AND DEVICE FOR RENDERING DOCUMENT

(71) Applicants: BEIJING FOUNDER APABI TECHNOLOGY LTD., Beijing (CN); PEKING UNIVERSITY FOUNDER GROUP CO., LTD., Beijing (CN)

(72) Inventors: Zhensheng HE, Beijing (CN); Guofeng XING, Beijing (CN); Changsheng WANG, Beijing (CN)

(21) Appl. No.: 13/936,962

(22) Filed: Jul. 8, 2013

(30) Foreign Application Priority Data
Jul. 9, 2012 (CN) 201210237743.1

(51) Int. Cl. G06T 11/20

(52) U.S. Cl. CPC G06T 11/20
USPC 345/581

(57) ABSTRACT

A method and a device for rendering a document are disclosed.

### CROSS REFERENCE OF RELATED APPLICATIONS

This application claims the benefit of Chinese patent application No. 201210237743.1, filed on Jul. 9, 2012, which is incorporated by reference in its entirety as part of this application.

### TECHNICAL FIELD

The present application refers to a method and a device for rendering electronic documents.

### BACKGROUND

A format of an electronic document can be converted by virtual printing. During the virtual printing, an image-text in the original electronic document can be divided into a series of primitive objects, such as characters, images and graphs. If there are complicated render effects like gradient effects, transparent effects, overlapping effects and cutting effects in the document, an sequence of the primitive objects will be formed during the virtual printing, and the formed primitive objects may be filled and rendered repeatedly in different printing areas. The rendering and/or the overlapping between normal primitive objects will be represented by corresponding raster operation codes.

### SUMMARY

In one aspect, there is provided a method for rendering a document. The method may comprise a step of obtaining primitive objects and raster operation codes thereof from the document. From the obtained primitive objects, primitive objects that need to be converted to image primitive objects are determined based on the obtained raster operation codes. Each of the determined primitive objects is then converted to an image primitive object, and then the converted primitive objects are rendered according to image properties and remain primitive objects of the obtained primitive objects are rendered according to their original properties.

In another aspect, there is provided a device for rendering a document. The device may comprise an obtaining module, a determining module and a converting module. The obtaining module is configured to obtain primitive objects and raster operation codes thereof from the document. The determining module is configured to determine primitive objects that need to be converted to image primitive objects based on the obtained raster operation codes, and the converting module is configured to convert each of the determined primitive objects to an image primitive object, and render the converted primitive objects according to image properties and remain primitive objects of the obtained primitive objects according to their original properties.

### BRIEF DESCRIPTION OF THE DRAWING

Exemplary non-limiting embodiments of the present invention are described below with reference to the attached drawings. The drawings are illustrative and generally not to an exact scale. The same or similar elements on different figures are referenced with the same reference numbers.

FIG. 1 is a flowchart of a method for processing the document according to an embodiment of the present application.

FIG. 2 is a flowchart of a method for processing the document according to another embodiment of the present application.

FIG. 3 is a schematic view of relative positions of each of the primitive objects according to an embodiment of the present application.

FIG. 4 is a block diagram of a device for processing a document according to an embodiment of the present application.

### DETAILED DESCRIPTION

Reference will now be made in detail to exemplary embodiments, examples of which are illustrated in the accompanying drawings. When appropriate, the same reference numbers are used throughout the drawings to refer to the same or like parts. A general principle of the technical solution in the embodiments of the present application is summarized as follows:

(1) The primitive objects in a document are divided into a first group with higher rendering accuracy, and a second group with lower rendering accuracy; and then

(2) the first group will be output/rendered according to its original properties so as to reduce storage space, and the second group will be output/rendered according to image properties so as to keep a good rendering accuracy.

Depending on different situations where the primitive objects will be converted to images, the procedure on how to determine the primitive objects to be converted may be different. Two different situations 1) and 2) are exemplified as below.

Situation 1)

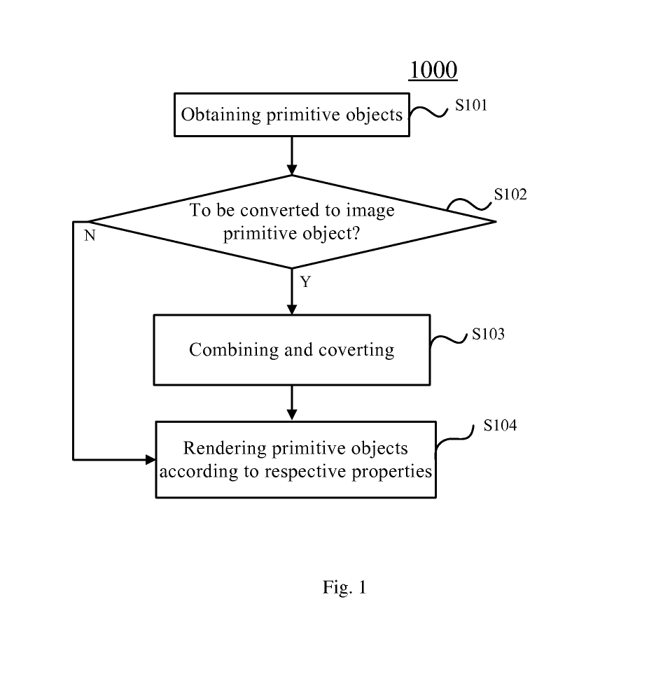

FIG. 1 illustrates a process 1000 for processing an electronic document in accordance with the situation 1). As shown in FIG. 1, the process 1000 begins with step S101, in which the primitive objects of the electronic document and their respective raster operation codes are obtained.

In a specific implementation, the primitive objects include image primitive objects, character primitive objects and graph primitive objects. The image primitive objects take up a lot of space for storage but can be rendered with a higher rendering accuracy, while the character primitive objects and the graph primitive objects take up less space for storage but sometimes may be rendered with a lower rendering accuracy. Of course, in the specific implementation, the primitive objects are not limited to the image primitive objects, character primitive objects and graph primitive objects, and other primitive objects may be involved if necessary.

In addition, the original data and corresponding raster operation codes of the character, image and graph objects may be obtained by utilizing character, image and graph processing functions of a virtual printing drive. The raster operation code is a value of a raster operation (ROP). In virtual printing, the obtained raster operation code is a quaternary raster operation code (i.e. ROP4), which is formed by four variables based on a source image pixel, a target image pixel, a template brush pixel and a mask bitmap.

The process 1000 then goes to step S102, in which, based on the obtained raster operation codes, each primitive object to be converted to an image primitive object is determined from the obtained primitive objects. In the situation 1), the primitive object that needs to be converted to an image primitive object is a primitive object having a special raster operation code. The special raster operation codes may comprise:

0xF0F0 (dest = pattern)
0x5A5A (dest = pattern XOR dest)
0xA0A0 (dest = source AND dest)
0x6666 (dest = source XOR dest)
0x8888 (dest = source AND dest)
0xEEEE (dest = source OR dest)

Such special raster operation codes generally mean that there are special effects like gradient and color overlay in the document, such as, WordArt, some color overlaid pages of MS PPT. During printing, the primitive objects having these special raster operation codes may involve multiple repetitious ROP operations, which may cause inaccurate rendering. Accordingly, by converting the primitive objects having the special raster operation codes to image primitive objects and then rendering the converted image primitive objects according to their image properties, the rendering accuracy can be improved.

In particular, if the raster operation code of a primitive object (for example, i^{th} primitive object, where i is an integer no larger than the amount of the obtained objects) is a special raster operation code, it is determined that this primitive object needs to be converted into an image primitive. The raster operation codes of the obtained primitive objects are determined one by one, until all of the primitive objects with special raster operation codes are determined as the primitive objects that need to be converted to the image primitive objects. For example, if the raster operation code of the i^{th} primitive object is 0x5A5A (dest=pattern XOR dest), such raster operation code is a special raster operation code, and thus the i^{th} primitive object is determined as a primitive object that needs to be converted to the image primitive object. Otherwise, if the raster operation code of the i^{th} primitive object is 0x1754 (dest=pattern XOR dest), such raster operation code is not a special raster operation code, and thus the i^{th} primitive object does not need to be converted to the image primitive object.

After the primitive objects with the special raster operation codes is determined in step S102, the method goes to step S103, in which the determined primitive objects with the special raster operation codes will be combined into one object and then the combined object is converted to the image primitive object. This combination process can reduce repeated rendering operations on the overlapped area, and thus improved the rendering accuracy. Alternatively, the determined primitive objects with the special raster operation codes may be converted to the image primitive objects, respectively, without the procedure of combining. Then the presses goes to step S104, in which the converted image primitive objects will be rendered according to their image properties, while the primitive object without a special raster operation code will be rendered directly according to its original properties. That is, the document has been changed as having different format from its original format. Accordingly, the processing of rendering will became simple and quick.

Situation 2)

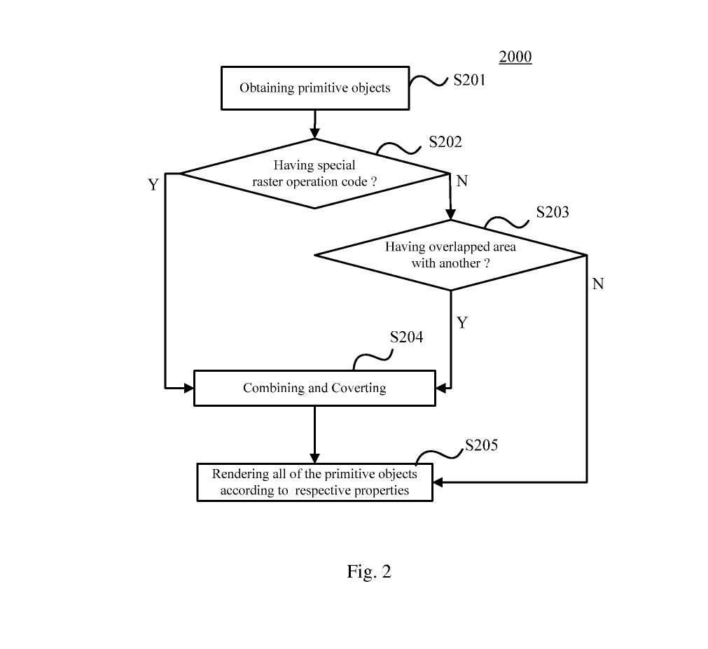

In the second situation, the primitive object that needs to be converted to an image is such a primitive object that not only has a special raster operation code but also has an overlapped area with other primitive object with a special raster operation code. FIG. 2 is a flowchart of a process 2000 for processing the document according to another embodiment of the present application, which is corresponding to this situation.

As shown in FIG. 2, the process 2000 begins with step S201, in which the primitive objects of the electronic document and their respective raster operation codes are obtained. And then in step S202, it is determined whether or not there is a primitive object of the obtained primitive objects that needs to be converted to an image primitive object. In particular, it is determined whether or not the raster operation code of an obtained primitive object (for example, i^{th} primitive object, wherein i is an integer lager than or equal to 1 and less than the number of the obtained primitive objects) is a special raster operation code. If yes, the i^{th} primitive object is determined as a primitive object that needs to be converted to an image primitive object.

If the raster operation code of the i^{th} primitive object is not a special raster operation code in step S202, the method goes to step S203 to further determine whether or not each of the obtained primitive objects (for example, i^{th} primitive object) has an overlapped area with another primitive object with a special raster operation code. If yes, the primitive object having an overlapped area with another primitive object with a special raster operation code is determined as the primitive object that needs to be converted to the image primitive object.

Even if the raster operation code of the obtained primitive object is not the special raster operation code, a technical problem of inaccurate rendering still exists. Thus, such a primitive object still needs to be converted to the image primitive object so as to maintain a good rendering accuracy. Specifically, the raster operation code of each of the obtained primitive objects is determined one by one, until all of the primitive objects with special raster operation codes are determined as the primitive objects that need to be converted to the image primitive objects (i.e. let i=i+1 until i is equal to the number of the obtained primitive objects). If a primitive object neither is the primitive object with a special raster operation code, nor has the overlapped area, generally it is not likely to cause a rendering error. This means that such a primitive object does not need to be converted to the image primitive object. Thus, such a primitive object may be rendered according to their original properties.

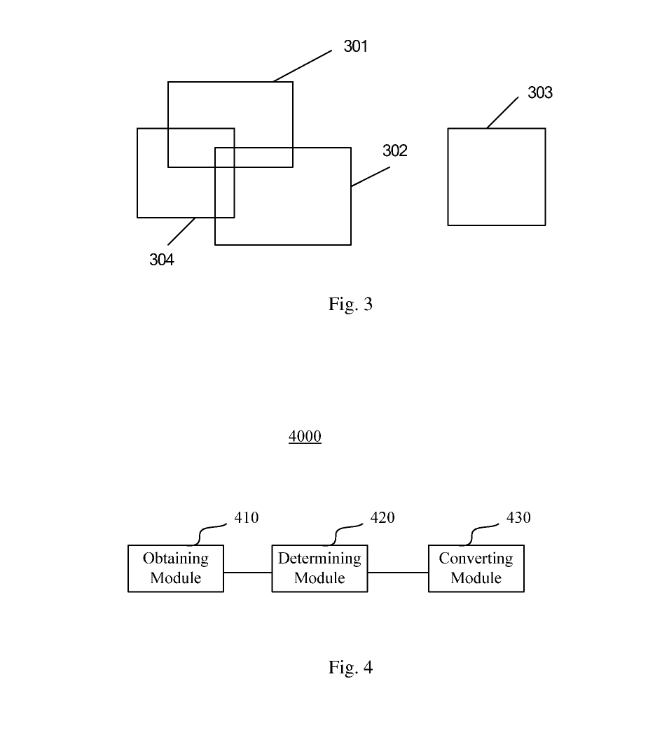

And then in step S204, the determined primitive object with the special raster operation codes will be combined into one object and the combined object is converted to one image primitive objects. This combination process can reduces repeated rendering operations on the overlapped area, and thus improved the rendering accuracy. For example, as shown in FIG. 3, the primitive objects 301, 302 and 304 have overlapped areas, but the area of the primitive object 302 stay separately. Under this circumstance, the primitive objects 301, 302 and 304 may be combined into one primitive object, and then be converted to an image primitive object. Alternatively, the determined primitive objects with the special raster operation codes may be converted to the image primitive objects, respectively, without the procedure of combining.

The process 2000 then goes to step S205, in which the converted image primitive objects are rendered according to their image properties, while other primitive objects are rendered directly according to their original properties. That is, all of the primitive objects are rendered according to their respective properties.

Since some of the objects will be converted into image objects and then rendered according to the image properties and others of the objects will be rendered according to their original properties, the original format of the document has been changed.

The original property may, for example, include at least one of image property, graph property, and character property.

Hereinafter, a device 4000 for processing a document according to another embodiment of the present application will be discussed.

As shown in FIG. 4, the device 4000 comprises an obtaining module 410 for obtaining primitive objects and their raster operation codes from the document; a determining module 420 for determining, based on the obtained raster operation codes, the primitive object that needs to be converted to an image primitive object; an converting module 430 for converting each of the determined primitive object to an image primitive object and then rendering all of the primitive objects according to their respective properties.

Depending on different situations of the primitive objects to be converted to images, the determining procedure of the determining module 420 may be different. For example, in the above mentioned situation 1), the determining module 420 operates to determine the raster operation code of the i^{th} primitive object of the obtained primitive objects is a special raster operation code, wherein i is an integer no larger than the amount of the obtained objects. If yes, the i^{th} primitive object will be considered as such a primitive object that needs to be converted to the image primitive object; otherwise, it is determined the i^{th} primitive object does not needs to be converted to the image primitive object. While in the above mentioned situation 2), if the determining module 420 determines that the raster operation code of the i^{th} primitive object is not a special raster operation code, it further determines if this primitive object has an overlapped area with another primitive object with a special raster operation code. If yes, the primitive object having an overlapped area with another primitive object with the special raster operation code is determined as the primitive object that needs to be converted to the image primitive object.

As an option, the converting module 430 may combine the determined primitive objects that need to be converted into one primitive object, and then convert the combined object to the image primitive objects.

The embodiments of the present invention may be implemented using certain hardware, software, or a combination thereof. In addition, the embodiments of the present invention may be adapted to a computer program product embodied on one or more computer readable storage media (comprising but not limited to disk storage, CD-ROM, optical memory and the like) containing computer program codes, which may be carried out by one or more processor in a computer system.

In the foregoing descriptions, various aspects, steps, or components are grouped together in a single embodiment for purposes of illustrations. The disclosure is not to be interpreted as requiring all of the disclosed variations for the claimed subject matter. The following claims are incorporated into this Description of the Exemplary Embodiments, with each claim standing on its own as a separate embodiment of the disclosure.

Moreover, it will be apparent to those skilled in the art from consideration of the specification and practice of the present disclosure that various modifications and variations can be made to the disclosed systems and methods without departing from the scope of the disclosure, as claimed. Thus, it is intended that the specification and examples be considered as exemplary only, with a true scope of the present disclosure being indicated by the following claims and their equivalents.

What is claimed is:

1. A computer-implemented method for rendering a document, comprising:
obtaining primitive objects and raster operation codes thereof from the document;
determining primitive objects that need to be converted to image primitive objects based on the obtained raster operation codes;
converting each of the determined primitive objects to an image primitive object; and
rendering the converted primitive objects according to image properties and remain primitive objects of the obtained primitive objects according to their original properties.

2. The method according to claim 1, wherein in the step of determining, primitive objects of the obtained primitive objects, which have special raster operation codes, are determined to be converted to the image primitive objects.

3. The method according to claim 1, wherein the determining comprises:
determining if there is a primitive object of the obtained primitive objects that has a special raster operation code;
if yes, determining the primitive object having the special raster operation code needs to be converted to the image primitive object; otherwise,
further determining if the primitive object without the special raster operation code is overlapped with another primitive object with a special raster operation code;
if yes, the primitive object is determined to be converted to the image primitive object.

4. The method according to claim 2, wherein the special raster operation code is a raster operation code for multiple raster operations.

5. The method according to claim 3, wherein the special raster operation code is a raster operation code for multiple raster operations.

6. The method according to claim 1, wherein the converting further comprises:
combining the determined primitive objects into one primitive object; and
converting the combined primitive object to the image primitive objects.

7. A device for rendering a document, comprising:
an obtaining module configured to obtain primitive objects and raster operation codes thereof from the document;
a determining module configured to determine primitive objects that need to be converted to image primitive objects based on the obtained raster operation codes; and
a converting module configured to convert each of the determined primitive objects to an image primitive object, and render the converted primitive objects according to image properties and remain primitive objects of the obtained primitive objects according to their original properties.

8. The device according to claim 7, wherein the determining module is configured to identify primitive objects of the obtained primitive objects, which have special raster operation codes, wherein the identified primitive objects are needed to be converted to the image primitive object.

9. The device according to claim 7, wherein the determining module is configured to determine if there is a primitive object of the obtained primitive objects that has a special raster operation code; if yes, the primitive object having the special raster operation code needs to be converted to the image primitive object; otherwise,
the determining module further determine if the primitive object without the special raster operation code is overlapped with another primitive object with a special raster operation code; if yes, the primitive object is determined to be converted to the image primitive object.

10. The device according to claim 7, wherein the converting module is further configured to combine the determined primitive objects into one primitive object and then convert the combined object to the image primitive object.

11. A device for rendering a document, comprising:
a processor configured to:
obtain primitive objects and raster operation codes thereof from the document;
determine primitive objects that need to be converted to image primitive objects based on the obtained raster operation codes;
convert each of the determined primitive objects to an image primitive object, and render the converted primitive objects according to image properties and remain primitive objects of the obtained primitive objects according to their original properties.

12. The device according to claim 11, wherein the processor is configured to convert each of primitive objects of the obtained primitive objects, which has special raster operation codes, to the image primitive objects.

13. The device according to claim 12, wherein the processor is further configured to combine the primitive objects of the obtained primitive objects with special raster operation codes into one primitive object and then convert the combined object to the image primitive object.

14. The device according to claim 11, wherein the processor is configured to identify primitive objects, which do not have the special raster operation code but is overlapped with another primitive object with a special raster operation code, and then convert the identified primitive objects to the image primitive objects.

15. The device according to claim 14, wherein the processor is further configured to combine the identified objects into one primitive object and then convert the combined object to the image primitive object.
